(19) United States
(12) Patent Application Publication
(10) Pub. No.: US 2009/0274876 A1
(43) Pub. Date: Nov. 5, 2009

(54) MATCH OF TWO BRIGHTNESS ENHANCEMENT FILMS

(76) Inventor: Dong-Yih Liou, Chung Li City (TW)

Correspondence Address: LEONG C LEI, PMB # 1008, 1867 YGNACIO VALLEY ROAD, WALNUT CREEK, CA, 94598, US

(21) Appl. No.: 12/111,985

(22) Filed: Apr. 30, 2008

(51) Int. Cl. B32B 3/30

(52) U.S. Cl. 428/167

(57) ABSTRACT

A match of two brightness enhancement films including a first brightness enhancement film having laterally arranged microstructures and a second brightness enhancement film having longitudinally arranged microstructures. The microstructures of one of the brightness enhancement films include lenses, while those of the other one of the brightness enhancement films are either lenses or prisms. The match of two brightness enhancement films features light condensation in both longitudinal and lateral directions and realization of optimized brightness and viewing angle for liquid crystal displays (LCDs) with the different microstructure configurations formed on the two brightness enhancement films.

### BACKGROUND OF THE INVENTION

(a) Technical Field of the Invention

The present invention relates to a match of two brightness enhancement films, in particular to an applicable technique to a backlight module of liquid crystal display (LCD). The match of two brightness enhancement films not only realize light condensation in both longitudinal and lateral directions but also optimize brightness and viewing angle of the LCD by means of different configurations of the microstructures.

(b) Description of the Prior Art

A conventional liquid crystal display (LCD) comprises one or more lightness enhancement films interposed between an LCD panel and a diffuser film or a light guide plate so that the light that exits the light guide plate or the diffuser film is refracted by the brightness enhancement film(s) to condense to the front direction of the display, and enhanced brightness can be realized in the front direction of the display.

As shown in FIG. 1 of the attached drawings, the match of two conventional brightness enhancement films, which comprises a first brightness enhancement film (1) having longitudinally arranged prism microstructures and a second bright enhancement film (2) having laterally arranged prism microstructures. The two brightness enhancement films are stacked to refract light exiting a light guide plate or a diffuser film so as to condense to the front direction of the display

In practical applications of the brightness enhancement films, the brightness enhancement film functions to enhance visual brightness of a display in the front direction. However, condensation of the exiting light decreases the viewing angle of the display. The match of two conventional brightness enhancement films are both made up of prismatic microstructures wherein the prisms have inclined but flat side surfaces, which are of fixed inclination angles so that when the incident light is received at a fixed angle, the exiting light is also emitted at a fixed angle. This imposes limitation to the viewing angle, and is thus not satisfactory for the needs of large viewing angle of large displays.

FIG. 2 shows another known brightness enhancement film (3), which is also made up of prism microstructures (4), wherein the prisms have inclined side surfaces and a rounded apex section (5). Since the rounded section provides increased range of light exiting angle, an increased viewing angle may obtain. However, the increased viewing angle may obtain at the expense of deterioration of brightness in the front direction. Further, the rounded section is set at the top of the prism so that the location and curvature cannot be adjusted to accommodate various incidence angle of the incident light to actually control the exiting angle of the exiting light. Thus, such a known brightness enhancement film may suffer either too low brightness or too small viewing angle and is incapable to provide satisfactory results for both brightness and viewing angle.

It is known that the success of commercial use of an invention relies not only on the realization of the desired function of such an invention, but also on meeting product requirements. Thus, the present invention is aimed to provide a match of two brightness enhancement films, which can satisfy the requirement of large LCD products and which not only realize light condensation but also optimize brightness and viewing angle.

### SUMMARY OF THE INVENTION

The primary purpose of the present invention is to provide a match of two brightness enhancement films, which features light condensation in both longitudinal and lateral directions and which realizes optimized brightness and viewing angle for liquid crystal displays (LCDs) with different configurations of microstructures formed on the two brightness enhancement films.

One of the factors that a brightness enhancement film may affect the viewing angle of a display is the shape of the microstructure thereof. Thus, when a first brightness enhancement film having longitudinally arranged microstructures and a second brightness enhancement film having laterally arranged microstructures are used in the stacked match, if the microstructures are identical for both brightness enhancement films, then horizontal and vertical viewing angles of the display are also the same. On the other hand, if the microstructures of the two brightness enhancement films are different, then the viewing angles are different.

Based on the principle described above, the present invention provides a match of two brightness enhancement films, which comprises a first brightness enhancement film having longitudinally arranged microstructures and a second brightness enhancement film having laterally arranged microstructures, which are stacked to form the match. The microstructures of one of the brightness enhancement films are comprised of lenses, each having a cross section delimited by two inclined side faces on opposite sites of an apex, wherein one of the side faces comprises at least an arcuate or curved surface, or both side faces comprise at least an arcuate or curved surface. The microstructures of another one of the brightness enhancement films are comprised of lenses or prisms. Condensation of light occurs in the lateral direction when light passes through the longitudinally arranged microstructures; and similarly, condensation of light occurs in the longitudinal direction when the light passes through the laterally arranged microstructures. If the longitudinally arranged microstructures and the laterally arranged microstructures are of different structures, then the ranges of exiting light angle are different for both microstructures, whereby different horizontal and vertical viewing angles can be realized. As such, the present invention features both light condensation in both longitudinal and lateral directions and realization of optimized brightness and viewing angle for liquid crystal displays (LCDs) with the different microstructure configurations formed on the two brightness enhancement films.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a known match of two conventional brightness enhancement films;

FIG. 2 is an end view of another conventional brightness enhancement film;

FIG. 3 is a perspective view, in an exploded form, of a match of two brightness enhancement films constructed in accordance with a first embodiment of the present invention;

FIG. 4 is an end view of a portion of the brightness enhancement film that constitutes the match in accordance with the first embodiment of the present invention, illustrating that lens microstructures that constitute the brightness enhancement film has a side face that is comprised of an arcuate or curved surface;

FIG. 5 is similar to FIG. 4 but showing lens microstructures that constitute a modification of the brightness enhancement film of the first embodiment of the present invention has two side faces that are both comprised of an arcuate or curved surface;

FIG. 6 is a perspective view of the match of two brightness enhancement films in accordance with the first embodiment of the present invention, wherein the two brightness enhancement films are stacked to form the match;

FIG. 7 is a perspective view of a match of two brightness enhancement films in accordance with a second embodiment of the present invention;

FIG. 8 is a perspective view, partially sectioned, of a match of two brightness enhancement films in accordance with a third embodiment of the present invention, wherein two brightness enhancement films are stacked but in opposite directions to form the match;

FIG. 9 is an end view of a brightness enhancement film that is used to make up a match of two brightness enhancement films in accordance with any of the embodiments of the present invention, illustrating a light diffusion structure added to the brightness enhancement film;

FIG. 10 is a plane view showing a brightness enhancement film that is used to make up a match of two brightness enhancement films in accordance with any of the embodiments of the present invention, illustrating the microstructures of the brightness enhancement film are of a left-and-right curved configuration; and

FIG. 11 is a side elevational view showing a match of two brightness enhancement films in accordance with any of the embodiments of the present invention, illustrating the microstructures of one of the brightness enhancement films that make up the match are of an up-and-down wavy configuration.

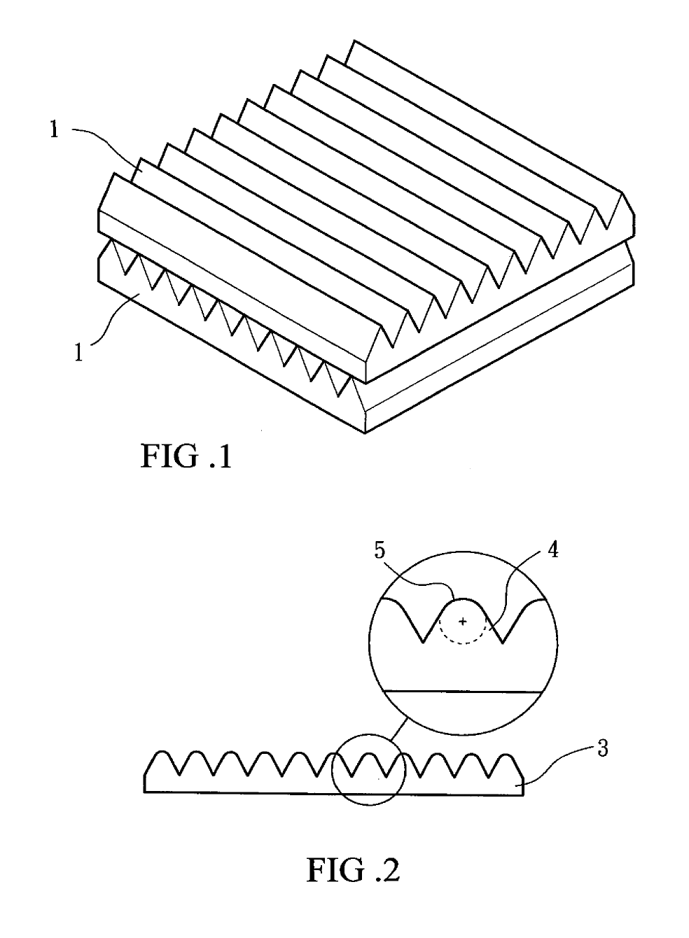

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

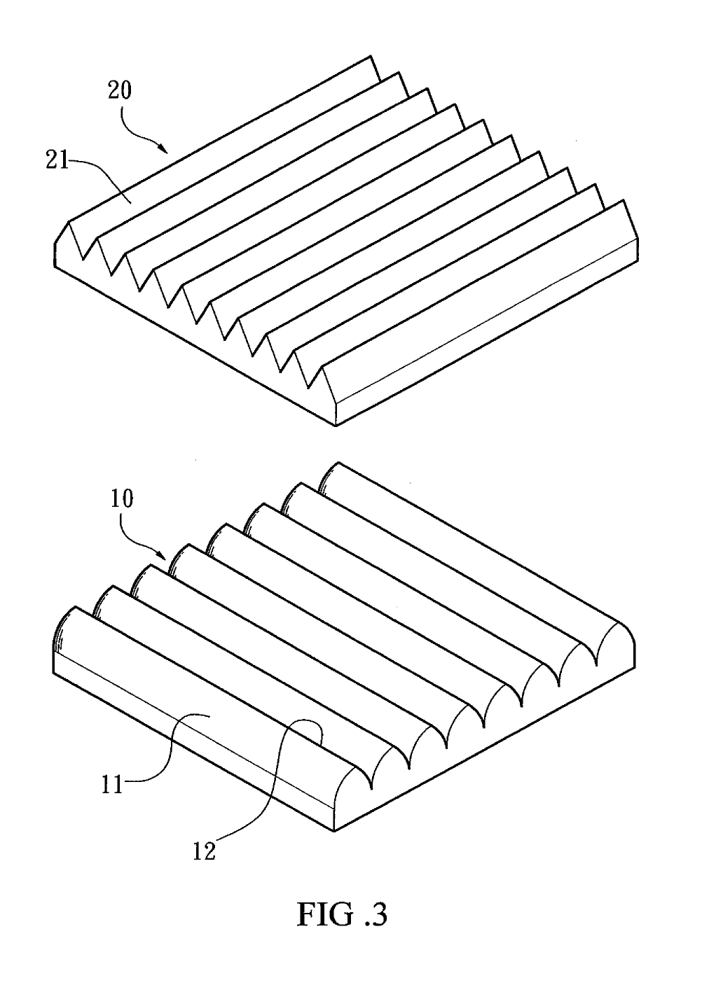

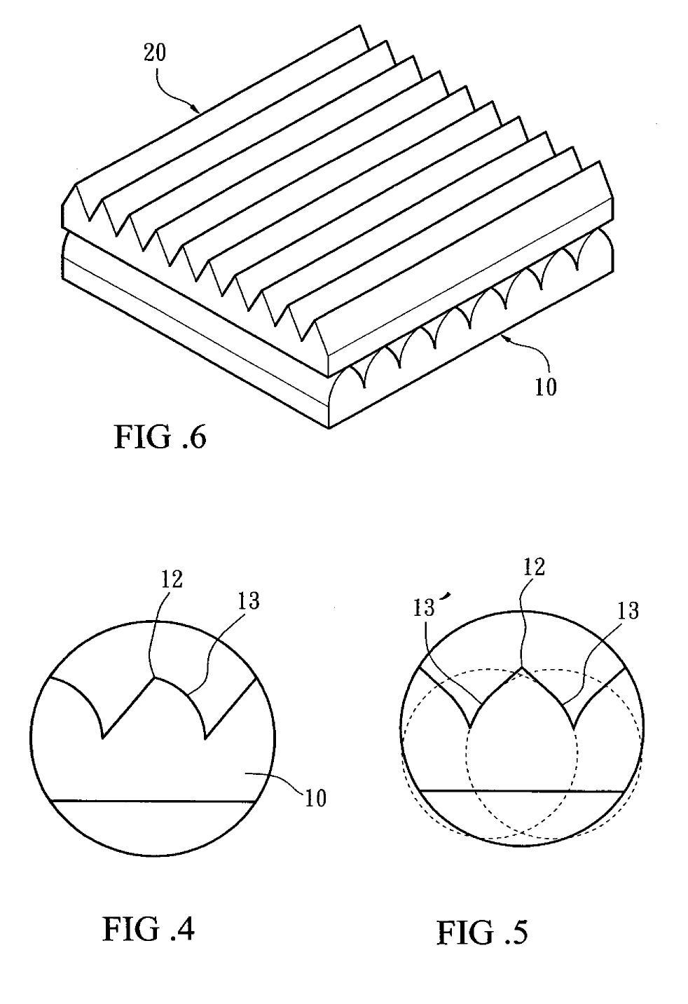

With reference to the drawings and in particular to FIG. 3, which shows an exploded view of a match of two brightness enhancement films in accordance with a first embodiment of the present invention, the match in accordance with the present invention comprises a first brightness enhancement film (10) that comprises a plurality of lens microstructures (11) that are laterally arranged and a second brightness enhancement film (20) that comprises a plurality of prism microstructures (21) that are longitudinally arranged. As shown in FIG. 4, each of the laterally arranged lens microstructure (11) has a cross section comprised of an apex (12) and two side faces that are substantially inclined and extend downward from the apex. One of the side faces is an inclined flat surface, while the other one forms at least one arcuate or curved surface (13); or alternatively, as shown in FIG. 5, both side faces of the lens microstructure (11) are comprised of at least one arcuate or curved surface (13, 13′). The longitudinally arranged prism microstructures (21) can be of sharp-angled apex or a rounded apex (5) as shown in FIG. 2.

Also referring to FIG. 6, the first and second brightness enhancement films (10, 20) are stacked to form the match in accordance with the present invention.

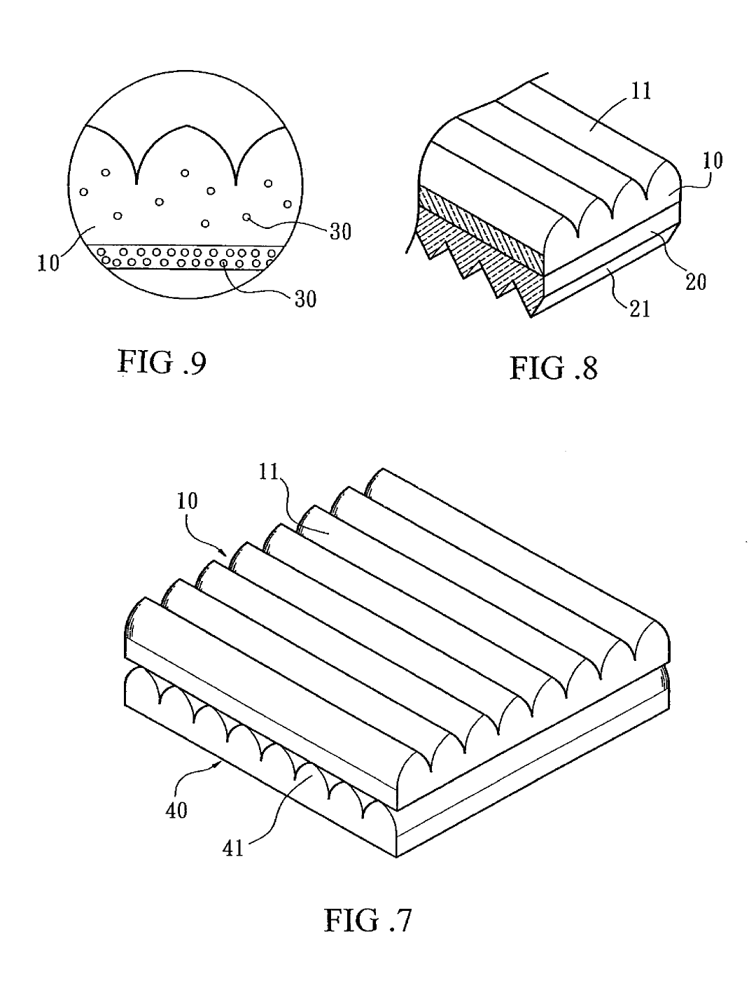

Also referring to FIG. 7, which shows a match of two brightness enhancement films in accordance with a second embodiment of the present invention, the match of the second embodiment comprises a first brightness enhancement film (10) that comprises a plurality of lens microstructures (11) that are laterally arranged and a second brightness enhancement film (40) that comprises a plurality of lens microstructures (41) that are longitudinally arranged. The laterally arranged lens microstructures (11) of the first brightness enhancement film (10) can be identical to the laterally arranged lens microstructures (11) of the first brightness enhancement film of the first embodiment described above. The longitudinally arranged lens microstructures (41) of the second brightness enhancement film (40) are also of the same structures as the laterally arranged lens microstructures (11), except extending in different directions.

Also referring to FIG. 8, which shows a match of two brightness enhancement films in accordance with a third embodiment of the present invention, the match of the third embodiment comprises the first and second brightness enhancement films (10, 20) (or the first and second brightness enhancement films (10, 40)), wherein the apexes (12) of the laterally arranged microstructures are oriented upward, while the apexes (12) of the longitudinally arranged lens microstructures are oriented downward. In other words, the laterally arranged microstructures and the longitudinally arranged microstructures of the match in accordance with the third embodiment are set to face opposite directions.

Referring to FIG. 9, for all the embodiments of the present invention described above, both brightness enhancement films (10, 20) or (10, 40) can incorporate therein a light diffusion structure (30). The diffusion structure (30) can be an externally attached structure that is molded on the undersurface of the brightness enhancement film, or formed by coating diffusion materials on the undersurface of the brightness enhancement film, and/or the diffusion structure (30) is formed by adding diffusion materials into the brightness enhancement film.

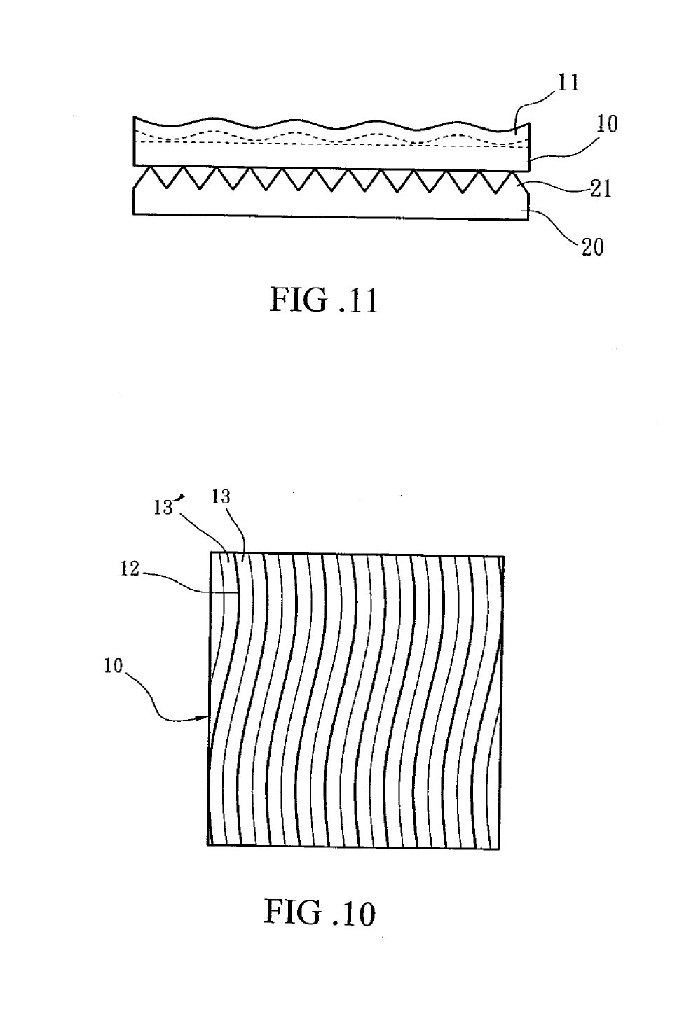

As shown in FIG. 10, for all the embodiments of the present invention described above, the microstructures (11, 21, 41) of the brightness enhancement films (10, 20) or (10, 40) that make up the match in accordance with the present invention can be of a left-and-right curved configuration.

As shown in FIG. 11, for all the embodiments of the present invention described above, the microstructures (11, 21, 41) of the brightness enhancement films (10, 20) or (10, 40) that make up the match in accordance with the present invention can be of an up-and-down wavy configuration.

For all the embodiments described above, the first brightness enhancement film (10) that carries the laterally arranged microstructures can be arranged above the second brightness enhancement films (20, 40) that carry the longitudinally arranged microstructures, or they can be arranged in reversed sequence.

For all the embodiments described above, the directions of arrangements of the microstructures for the brightness enhancement films (10, 20) or (10, 40) can intersect at an angle between 45 to 135 degrees and preferably they intersect each other by 90 degrees.

For all the embodiments described above, the two brightness enhancement films (10, 20) are stacked. They can be formed together as an integral member.

For all the embodiments described above, the two brightness enhancement films (10, 20) or (10, 40) can interpose there between at least one diffuser film to enhance diffusion of the exiting light and to make the brightness more uniform.

To conclude, the match of two brightness enhancement films in accordance with the present invention realizes the desired effect and can be of use to the modern industry. Most importantly, the present invention overcomes the problems that the conventional brightness enhancement film cannot satisfy the large viewing angle required for large-sized liquid crystal displays, while maintaining the brightness in the front direction, whereby the present invention allows for optimization of both brightness and viewing angle for liquid crystal displays.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A match of two brightness enhancement films comprising a first brightness enhancement film having laterally arranged microstructures and a second brightness enhancement film having longitudinally arranged microstructures, the two brightness enhancement films being stacked, characterized in that the microstructures of one of the brightness enhancement films comprise lenses each having a cross section delimited by two inclined side faces on opposite sites of an apex, wherein one of the side faces comprises at least an arcuate or curved surface, or two side faces both comprise at least an arcuate or curved surface, the microstructures of the other one of the brightness enhancement films being comprised of prisms or lenses.

2. The match of two brightness enhancement films as claimed in claim 1, wherein the brightness enhancement film having laterally arranged microstructures is selectively positioned above or below the brightness enhancement film having longitudinally arranged microstructures.

3. The match of two brightness enhancement films as claimed in claim 1, wherein the prisms of the microstructures of said other one of the brightness enhancement films has a sharp-angled apex or a rounded apex.

4. The match of two brightness enhancement films as claimed in claim 1, wherein the microstructures of said one and said other one of the brightness enhancement films are substantially identical.

5. The match of two of brightness enhancement films as claimed in claim 1, wherein the microstructures of said other one of the brightness enhancement films has an apex oriented in the same direction as the apex of the microstructures of said one of the brightness enhancement films.

6. The match of two of brightness enhancement films as claimed in claim 1, wherein both of the brightness enhancement films are provided with a light diffusion structure, which is integrally molded on an undersurface of each brightness enhancement film, or which is formed by coating diffusion materials on the undersurface, and/or which is formed by adding diffusion materials in the brightness enhancement film.

7. The match of two of brightness enhancement films as claimed in claim 1, wherein the microstructures of both brightness enhancement films are selectively of a left-and-right curved configuration or an up-and-down wavy configuration.

8. The match of two of brightness enhancement films as claimed in claim 1, wherein the arrangements of the microstructures of the two brightness enhancement films are set to intersect at an angle between 45 to 135 degrees.

9. The match of two of brightness enhancement films as claimed in claim 1, wherein the first and second brightness enhancement films are integrally formed together.

10. The match of two of brightness enhancement films as claimed in claim 1 further comprising at least one diffusion film interposed between the first and second brightness enhancement films.
